(19) United States
(12) Patent Application Publication
(10) Pub. No.: US 2026/0333058 A1
(43) Pub. Date: Oct. 22, 2026

(54) METHODS AND SYSTEMS FOR MANAGING WIRELESS ACCESS POINTS

(71) Applicant: Versa Networks, Inc., Santa Clara, CA (US)

(72) Inventors: Rajesh Kumar Nuvvula, Lathrop, CA (US); Apurva Mehta, Cupertino, CA (US)

(21) Appl. No.: 19/180,659

(22) Filed: Apr. 16, 2025

(51) Int. Cl. H04W 16/14

(52) U.S. Cl. CPC H04W 16/14

(57) ABSTRACT

Methods, a non-transitory computer readable medium, and systems for operating a network are disclosed. In an example, multiple wireless APs are centrally managed by a network manager, information about DFS events can be provided to the network manager and information about spatially grouped wireless APs can be used by the network manager to notify nearby wireless APs to avoid an RF channel at which a radar signal has been detected by a different wireless AP. In an example, the wireless APs that are notified of the RF channel to avoid are wireless APs that have been determined to be spatially grouped with the wireless AP that provided the DFS event notification to the network manager. The notified wireless APs can then temporarily avoid the corresponding RF channel during scanning.

### CROSS-REFERENCE TO RELATED APPLICATION

This application is related to co-pending U.S. Patent Application Serial Number XX/XXX,XXX, filed Apr.16, 2025, entitled METHODS AND SYSTEMS FOR OPERATING WIRELESS ACCESS POINTS.

### BACKGROUND

Software-defined wide area network (SD-WAN) architectures allow enterprise networks to be centrally managed to provide, for example, security and policy enforcement across various remote sites. On premise equipment of an SD-WAN can provide SD-WAN capabilities, security services (e.g., firewall, IPS/IDS, URL filtering), and traffic optimization. Wireless access points (APs) can be included with the on-premise equipment to provide wireless connectivity to wireless client devices at the enterprise site. As enterprise networks add more wireless APs at a site, it is important that the wireless APs be efficiently managed.

### SUMMARY

Methods, a non-transitory computer readable medium, and systems for operating a network are disclosed. In an example, a method for operating a network involves at a first wireless AP, generating a Dynamic Frequency Selection (DFS) event notification message in response to a radio frequency (RF) scanning operation that identifies a radar signal at an RF channel, the DFS event notification message including an identifier of the first wireless AP and an identifier of the RF channel, at the first wireless AP, transmitting the DFS event notification message to a network manager, at the network manager, identifying at least one wireless AP that is spatially grouped with the first wireless AP using the first wireless AP identifier that was included in the DFS event notification message, at the network manager, generating an avoid channel notification message in response to the DFS event notification message, the avoid channel notification message including the RF channel identifier that was included in the DFS event notification message, at the network manager, transmitting the avoid channel notification message to the at least one wireless AP that was identified as being spatially grouped with the first wireless AP, and at the at least one wireless AP that was identified as being spatially grouped with the first wireless AP, receiving the avoid channel notification message and implementing an RF scanning operation that excludes the RF channel that is identified by the RF channel identifier in the avoid channel notification message.

In an example, the avoid channel notification message includes an exclusion time, and wherein the RF channel is excluded from the RF scanning operation by the at least one wireless AP in accordance with the exclusion time included in the avoid channel notification message.

In an example, the RF channel is excluded from the RF scanning operation for a fixed period of time.

In an example, the RF channel is excluded from the RF scanning operation for 30 minutes.

In an example, identifying at least one wireless AP that is spatially grouped with the first wireless AP using the first wireless AP identifier that was included in the DFS event notification message includes finding wireless APs that have a group identifier that matches a group identifier of the first wireless AP.

In an example, the first wireless AP identifier is a media access control (MAC) address, and wherein identifying at least one wireless AP that is spatially grouped with the first wireless AP using the first wireless AP identifier that was included in the DFS event notification message includes finding the MAC addresses of wireless APs that have a group identifier that matches a group identifier of the first wireless AP.

In an example, the at least one wireless AP that was identified as being spatially grouped with the first wireless AP includes multiple wireless APs that are identified as being spatially grouped with the first wireless AP.

In an example, the method further involves at the network manager, transmitting the avoid channel notification message to the multiple wireless APs that are identified as being spatially grouped with the first wireless AP, and at each one of the multiple wireless APs that are identified as being spatially grouped with the first wireless AP, implementing an RF scanning operation that excludes the RF channel that is identified by the RF channel identifier in the avoid channel notification message.

In an example, the first wireless AP identifier is a media access control (MAC) address corresponding to the first wireless AP identifier.

In an example, the DFS event notification is transmitted from a wired interface of the first wireless AP.

In an example, the method involves at the first wireless AP, transmitting the DFS event notification message via a wired interface of the first wireless AP, and at the at least one wireless AP that was identified as being spatially grouped with the first wireless AP, receiving the avoid channel notification message via a wired interface of the at least one wireless AP.

An example of a non-transitory computer readable medium including instructions, which when executed by one or more processes, implement a method is disclosed. The method involves at a network manager, receiving a DFS event notification message, the DFS event notification message including an identifier of a first wireless AP and an identifier of an RF channel, at the network manager, identifying at least one wireless AP that is spatially grouped with the first wireless AP using the first wireless AP identifier that was included in the DFS event notification message, at the network manager, generating an avoid channel notification message in response to the DFS event notification message, the avoid channel notification message including the RF channel identifier that was included in the DFS event notification message, and at the network manager, transmitting the avoid channel notification message to the at least one wireless AP that was identified as being spatially grouped with the first wireless AP.

In an example, identifying at least one wireless AP that is spatially grouped with the first wireless AP using the first wireless AP identifier that was included in the DFS event notification message includes finding wireless APs that have a group identifier that matches a group identifier of the first wireless AP.

In an example, the first wireless AP identifier is a MAC address, and wherein identifying at least one wireless AP that is spatially grouped with the first wireless AP using the first wireless AP identifier that was included in the DFS event notification message includes finding the MAC addresses of wireless APs that have a group identifier that matches a group identifier of the first wireless AP.

In an example, the DFS event notification message is generated at a wireless AP in response to an RF scanning operation that identifies a radar signal at the RF channel, and further including at the at least one wireless AP that was identified as being spatially grouped with the first wireless AP, implementing an RF scanning operation that excludes the RF channel that is identified by the RF channel identifier in the avoid channel notification message.

An example of a wireless AP is disclosed. The wireless AP includes a wired interface, a wireless interface, and a processor and memory configured to generate a DFS event notification message in response to an RF scanning operation that identifies a radar signal at an RF channel, the DFS event notification message including an identifier of the first wireless AP and an identifier of the RF channel, transmit the DFS event notification message to a network manager via the wired interface, receive an avoid channel notification message at the wired interface, the avoid channel notification message including an RF channel identifier, and implement an RF scanning operation via the wireless interface that excludes the RF channel that is identified by the RF channel identifier in the avoid channel notification message.

In an example, the avoid channel notification message further includes an exclusion time, and wherein the processor and memory are configured to exclude the RF channel identified by the RF channel identifier from the RF scanning operation for the exclusion time.

In an example, the wireless interface operates according to an Institute of Electrical and Electronics Engineers (IEEE) 802.11 communication protocol.

An example of a non-transitory computer readable medium comprising instructions, which when executed by one or more processes, implement a method. The method involves generating a DFS event notification message in response to an RF scanning operation that identifies a radar signal at an RF channel, the DFS event notification message including an identifier of the first wireless AP and an identifier of the RF channel, transmitting the DFS event notification message to a network manager via a wired interface, receiving an avoid channel notification message at the wired interface, the avoid channel notification message including an RF channel identifier, and directing an RF scanning operation via a wireless interface that excludes the RF channel that is identified by the RF channel identifier in the avoid channel notification message.

In an example, the avoid channel notification message further includes an exclusion time, and wherein the method further includes excluding the RF channel identified by the RF channel identifier from the RF scanning operation for the exclusion time.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts an SD-WAN in which a node of the SD-WAN is connected to a network manager via a cloud services gateway and a wide area network such as the Internet.

FIG. 2 depicts an example of a set of RF channels that the wireless APs described with reference to FIG. 1 are configured to use.

FIG. 3 is a swim lane diagram that illustrates an example of a method for operating a network that involves sharing DFS channel information to improve the performance of the network.

FIG. 4A depict the set of RF channels from FIG. 2 and illustrates a CAC that is performed by a wireless AP that received the avoid channel notification to avoid channel 100.

FIG. 4B depicts the set of RF channels from FIG. 2 and illustrates a DFS scanning operation that is performed by a wireless AP that received the avoid channel notification to avoid channel 100 and the avoid channel notification to avoid channel 56.

FIG. 4C depicts the set of RF channels from FIG. 2 and illustrates a CAC that is performed by a wireless AP that received the avoid channel notification to avoid channel 56.

FIG. 5 is an example of a DFS event notification message that is sent from a wireless AP to the network manager as a DFS event notification.

FIG. 6 is an example of an avoid channel notification message that is sent from the network manager to a wireless AP as an avoid channel notification.

FIG. 7 is a process flow diagram of an example process that is implemented by a wireless AP.

FIG. 8 is a process flow diagram of an example process that is implemented by a network manager.

FIG. 9 is an example of a database that is maintained for use by a network manager to determine if any wireless APs are nearby to a wireless AP from which a DFS event notification was received.

FIG. 10 is an example of a floor diagram, or floor map, of a building that includes the locations of wireless APs.

FIG. 11 is another example of a floor diagram, or floor map, of a building that includes the locations of wireless APs.

FIG. 12 is a process flow diagram of another example process that is implemented by a wireless AP.

FIG. 13 is an example of a network manager that is configured to implement RF channel management as described herein.

FIG. 14 is a functional block diagram of a wireless AP that may be similar to any of the wireless APs described herein.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to "one embodiment", "an embodiment", or similar language means that a particular feature, structure, or characteristic described in connection with the indicated embodiment is included in at least one embodiment of the present invention. Thus, the phrases "in one embodiment", "in an embodiment", and similar language throughout this specification may, but do not necessarily, all refer to the same embodiment.

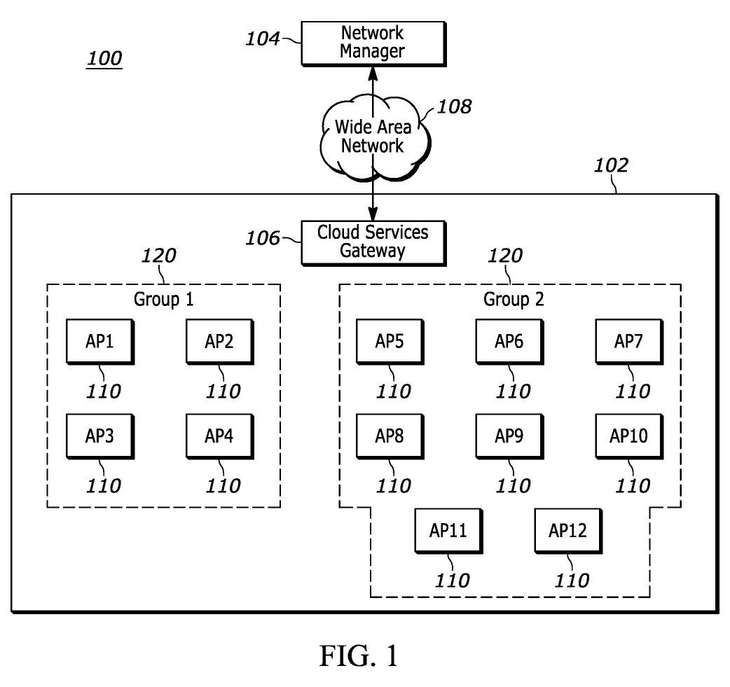

Examples are described herein in the context of a Software Defined Wide Area Network (SD-WAN or SDWAN) that includes nodes that are connected to a network manager through a wide area network such as the Internet. FIG. 1 depicts an SD-WAN 100 in which a node 102 of the SD-WAN is connected to a network manager 104 via a cloud services gateway 106 and a wide area network 108 such as the Internet. The node, which may be an enterprise site such as a building or multiple buildings that are associated with the same company, includes the cloud services gateway and multiple wireless access points (APs) 110 that are coupled with the cloud services gateway for data communications. For example, the wireless APs are coupled, either directly or indirectly (e.g., via network switches), to the cloud services gateway through wired interfaces of the wireless APs. In an example, the wireless APs are configured to operate according to Wi-Fi technologies (e.g., including the IEEE 802.11 suite of protocol standards created by the Institute of Electrical and Electronics Engineers (IEEE)) to communicate with wireless client devices (not shown). In the example of FIG. 1, the wireless APs, AP1 – AP12, are installed at an enterprise site as part of the data network at the enterprise site. Within the enterprise site, some wireless APs may be spatially group. For example, wireless APs may be spatially grouped when the wireless APs are located nearby to each other. In the example of FIG. 1, two spatial groups 120 of wireless APs are identified, group 1 and group 2. In some examples, the spatial groups may correspond to different areas within the same building, to different buildings, or to two different floors in the same building. Although some examples of spatial groups are described, spatial groups may correspond to other spatial characteristics. Additionally, although an example is described in the context of an SD-WAN, techniques described herein can be applied in non-software-defined networks.

Dynamic Frequency Selection (DFS) is a protocol in the IEEE 802.11h standard that is designed to prevent interference between Wi-Fi networks and radar systems operating in the 5 GHz band. DFS operates on specific DFS channels, which are portions of the 5 GHz spectrum shared with radar, while non-DFS channels exist in the same band but do not require DFS functionality. Before a wireless AP can operate on a DFS channel, the wireless AP performs a Channel Availability Check (CAC), which involves a listening period (typically 30 – 60 seconds) to ensure that no radar activity is present. If a radar signal is detected during a CAC, the wireless AP may initiate a Channel Switch Announcement (CSA) if the wireless AP was currently using an RF channel that overlaps with the radar signal. The CSA informs connected wireless client devices of an impending move to a different, interference-free, RF channel. Implementing the dynamic frequency selection process at a wireless AP helps the wireless AP and connected wireless client devices to maintain reliable Wi-Fi operation while ensuring compliance with regulatory requirements.

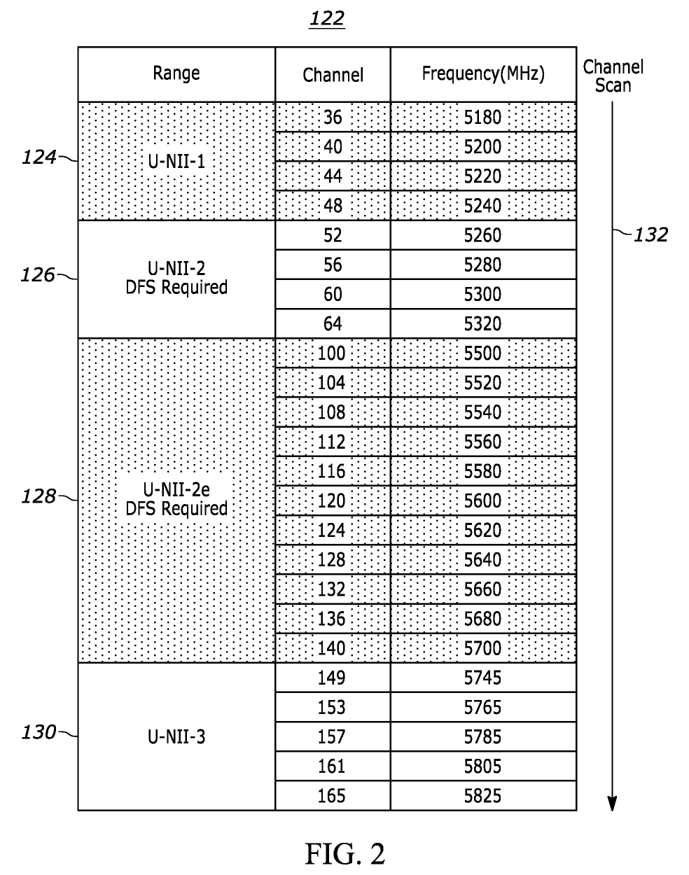

FIG. 2 depicts an example of a set of RF channels 122 that the wireless APs described with reference to FIG. 1 are configured to use. The RF channels include four different Unlicensed National Information Infrastructure (UNII) bands, UNII-1 124, UNII-2 126, UNII-2e 128, and UNII-3 130. As shown in FIG. 2, the 20 MHz RF channels in the UNII-1 band include RF channels 36, 40, 44, and 48, the 20 MHz RF channels in the UNII-2 band include RF channels 52, 56, 60, and 64, the 20 MHz RF channels in the UNII-2e band include RF channels 100, 104, 108, 112, 116, 120, 124, 128, 132, 136, and 140, and the 20 MHz RF channels in the UNII-3 band include RF channels 149, 153, 157, 161, and 165. Although FIG. 2 depicts only 20 MHz RF channels, the wireless APs may be configured to utilize RF channels having different bandwidths, such as 40 MHz, 80 MHz, and 160 MHz.

As indicated in FIG. 2, the UNII-2 126 and UNII-2e 128 bands require the wireless APs to have DFS capability. In an example, a scan operation 132 that is implemented by a wireless AP, referred to as a CAC, may involve the wireless AP scanning across the range of RF channels to see if there is a radar signal at any of the RF channels. According to the DFS protocol, if a radar signal is detected at one of the RF channels, the wireless AP can avoid use of that RF channel and may switch to an RF channel that is different from the RF channel that is currently being used by the wireless AP for wireless communications. As specified in the DFS protocol, if the wireless AP needs to switch RF channels, then the AP may issue a CSA that will be received by the wireless devices that are within the range of the wireless AP. In particular, the CSA is implemented through beacon frames that are transmitted from the wireless interface of the wireless AP.

As described above, the DFS protocol describes how a wireless AP can detect radar signals, switch to an available RF channel, and communicate the channel switch information to nearby wireless client devices. Although the DFS protocol works well to manage the operation of a particular wireless AP, each wireless AP is managing RF channel use independent of any other wireless APs and the DFS protocol does not provide for any coordination between multiple wireless APs that are nearby to each other. In the case of an enterprise site in which multiple wireless APs are nearby to each other, each wireless AP is continually scanning the available RF channels for radar signals and switching to available RF channels as needed. Thus, each wireless AP consumes valuable resources to scan the entire slate of RF channels to detect radar signals that may be impacting each of the wireless AP. It has been realized that when multiple wireless APs are centrally managed by a network manager, information about DFS events can be provided to the network manager and information about spatially grouped wireless APs can be used by the network manager to notify nearby wireless APs to avoid an RF channel at which a radar signal has been detected by a different wireless AP. In an example, the wireless APs that are notified of the RF channel to avoid are wireless APs that have been determined to be spatially grouped with the wireless AP that provided the DFS event notification to the network manager. The notified wireless APs can then temporarily avoid the corresponding RF channel during scanning, e.g., DFS scanning operations, at least because it is likely that the corresponding RF channel could negatively impact each of the wireless APs in the spatial group.

Thus, by maintaining information about spatially grouped wireless APs at a network manager, DFS event notifications from wireless APs can be intelligently leveraged to notify spatially grouped wireless APs to temporarily exclude an RF channel from scanning. Temporarily excluding an RF channel from scanning at nearby wireless APs reduces the load on the wireless interfaces of the wireless APs, which can result in improved performance of the wireless APs. In large network deployments that may include dozens if not hundreds of wireless APs at an enterprise, such centralized coordination of DFS channel information can significantly improve the performance of individual wireless APs and/or the overall performance of the network.

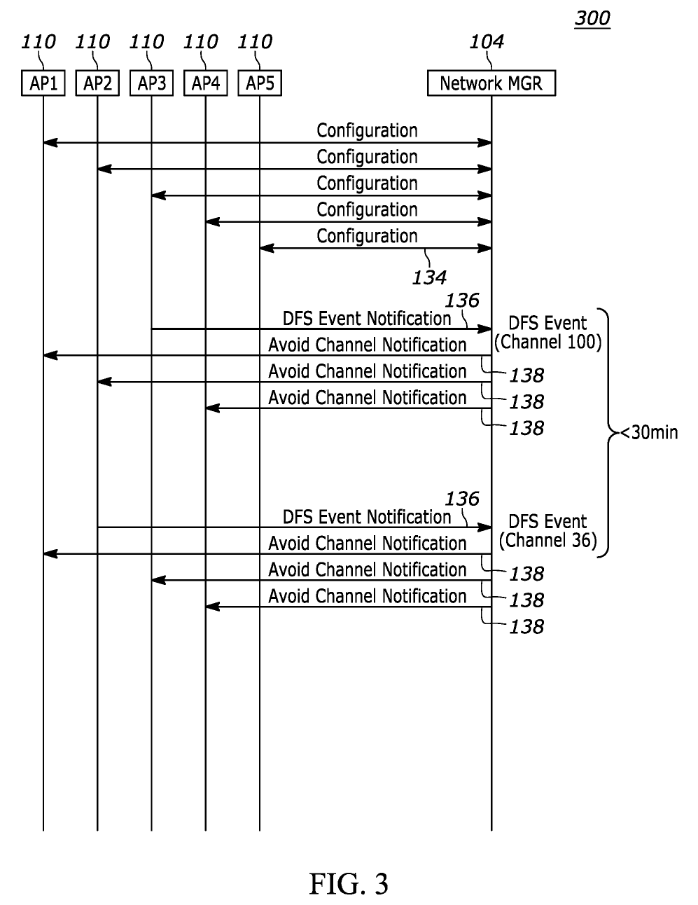

FIG. 3 is a swim lane diagram 300 that illustrates an example of a method for operating a network that involves sharing DFS channel information to improve the performance of the network. With reference to FIG. 3, the swim lane diagram includes swim lanes that correspond to five wireless APs 110, AP1 – AP5, and the network manager 104. In an example, the network manager is coupled to the wireless APs through an overlay network such as an SD-WAN as described with reference to FIG. 1. Although only five wireless APs are shown in FIG. 3, there may be more APs in a network that is managed by the network manager.

In a first operation, the wireless APs 110 and network manager 104 share configuration information 134 with each other. For example, the wireless APs may provide AP identifier information, such as a MAC address and device serial number to the network manager the network manager may push configuration information such as service set identifier (SSID), channel width, operating channel, and security information to the wireless APs and the.

In a next operation, the wireless AP 110, AP3, sends a DFS event notification 136 to the network manager 104. For example the DFS event notification may be sent to the network manager in response to the wireless AP detecting a radar channel at RF channel 100 via a CAC. In an example, the DFS event notification includes a wireless AP identifier, such as the MAC address of the wireless AP, and an RF channel identifier (e.g., RF channel 100). Upon receiving the DFS event notification, the network manager determines if there are any other wireless APs nearby to the wireless AP from which the DFS event notification was received. For example, a wireless AP is considered to be nearby to the wireless AP from which the DFS event notification was received if the wireless AP is associated with a group of wireless APs that includes the wireless AP from which the DFS event notification was received. In an example, each wireless AP includes a group identifier and wireless APs that have a matching group identifier are considered to be nearby, or spatially grouped, with the wireless AP from which the DFS event notification was received. In the example of FIG. 3, wireless APs, AP1, AP2, and AP4, are spatially grouped with the wireless AP, AP3, but wireless AP, AP5, is not spatially grouped with wireless AP, AP3.

In a next operation, avoid channel notifications 138 are sent from the network manager 104 to the wireless APs 110 that are spatially grouped with the wireless AP from which the DFS event notification was received. In the example of FIG. 3, avoid channel notifications are sent to wireless APs, AP1, AP2, and AP4. Upon receiving the avoid channel notifications, the wireless APs temporarily exclude RF channel 100 from their scanning. In an example, the wireless APs exclude RF channel 100 from their scanning for a fixed time interval of, for example, 30 minutes. In an example, wireless AP, AP3, switches to a non-DFS channel upon detecting channel 100 so that a CAC delay time (e.g., 60 seconds) can be avoided.

After some time, in a next operation, the wireless AP 110, AP2, sends a DFS event notification 136 to the network manager 104. For example the DFS event notification may be sent to the network manager in response to the wireless AP detecting a radar channel at RF channel 56 via a CAC. In an example, the DFS event notification includes a wireless AP identifier, such as the MAC address of the wireless AP, and an RF channel identifier (e.g., RF channel 100). Upon receiving the DFS event notification, the network manager determines if there are any other wireless APs nearby to the wireless AP from which the DFS event notification was received. For example, a wireless AP is considered to be nearby to the wireless AP from which the DFS event notification was received if the wireless AP is associated with a group of wireless APs that includes the wireless AP from which the DFS event notification was received. In an example, each wireless AP includes a group identifier and wireless APs that have a matching group identifier are considered to be nearby, or spatially grouped, with the wireless AP from which the DFS event notification was received. In the example, of FIG. 3, wireless APs, AP1, AP3, and AP4 are spatially grouped with the wireless AP, AP2, but wireless AP, AP5, is not spatially grouped with wireless AP, AP2.

In a next operation, avoid channel notifications 136 are sent from the network manager 104 to the wireless APs 110 that are spatially grouped with the wireless AP from which the DFS event notification was received. In the example of FIG. 3, avoid channel notifications are sent to wireless APs, AP1, AP3, and AP4. Upon receiving the avoid channel notifications, the wireless APs temporarily exclude RF channel 56 from their scanning. In an example, the wireless APs exclude RF channel 56 from their scanning for a fixed time interval of, for example, 30 minutes. In an example, wireless AP, AP3, switches to a non-DFS channel upon detecting the channel 56 so that a CAC delay time (e.g., 60 seconds) can be avoided.

In an example, the DFS event notifications 136 are sent from the wireless APs 110 to the network manager 104 via a wired interface of the wireless APs. The DFS event notifications are distinguished from any CSAs that may be transmitted to wireless client devices via the wireless interface of the wireless AP as specified in the DFS protocol.

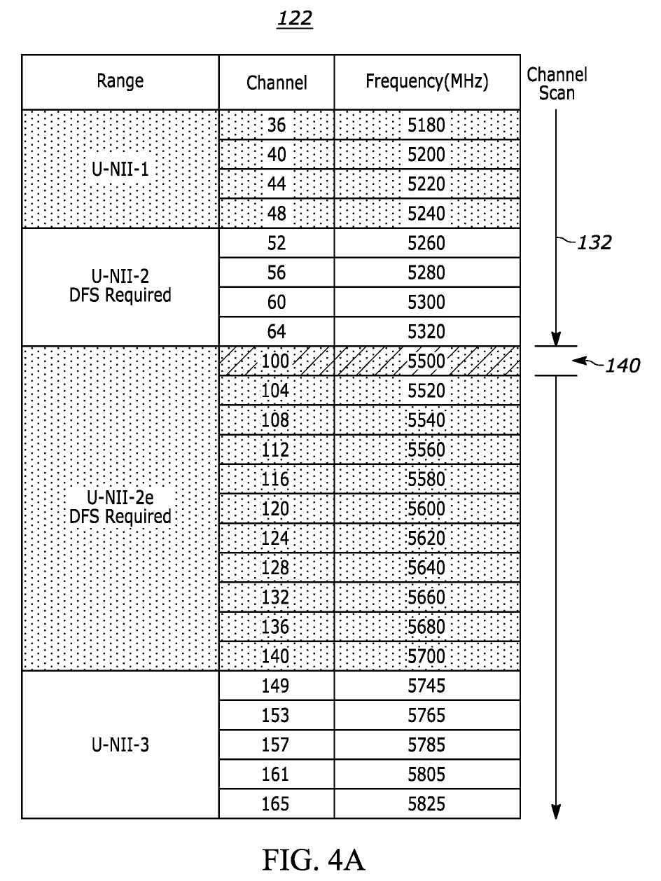

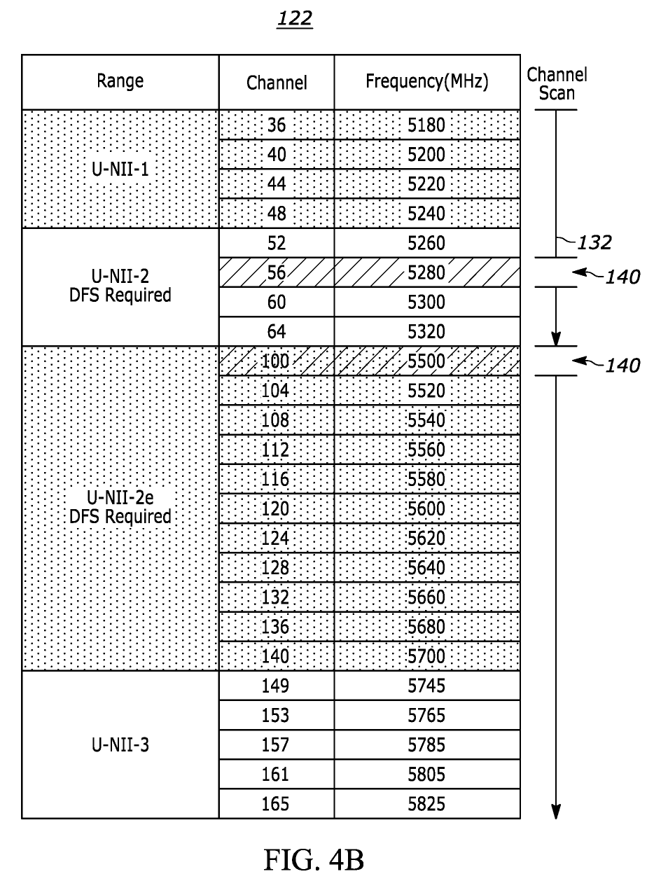

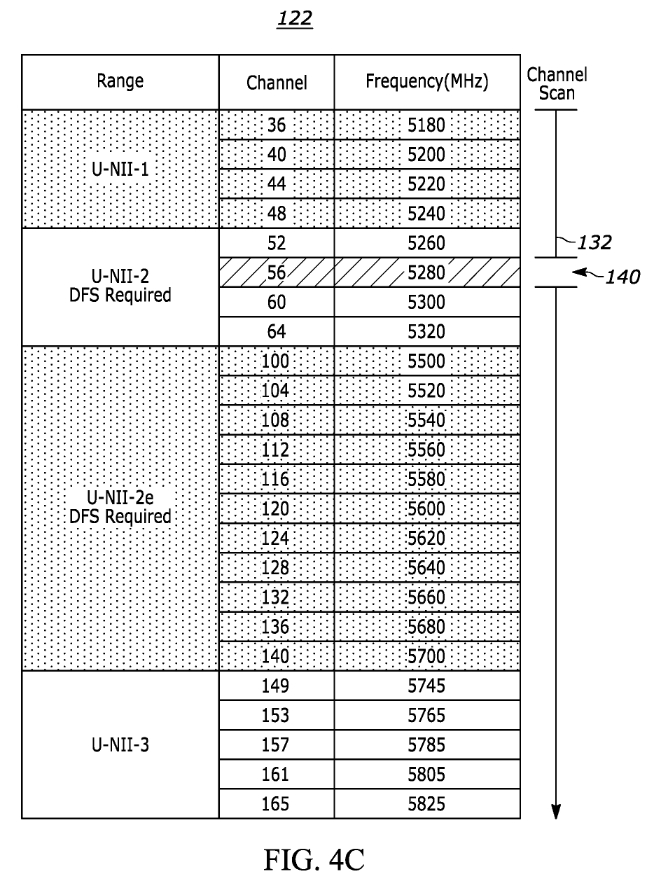

The operations described with reference to FIG. 3 are further described with reference to FIGS. 4A – 4C. FIG. 4A depict the set of RF channels 122 from FIG. 2 and illustrates a channel scan 132 that is performed by a wireless AP that received the avoid channel notification to avoid channel 100. As shown in FIG. 4A, channel 100 is excluded 140 from scanning implemented by the wireless AP. In the example of FIG. 3, channel 100 is excluded from scanning by wireless APs, AP1, AP2, and AP4. In addition to excluding channel 100 from scanning, in an example, the RF channel 100 is not used for wireless communications by the wireless AP that sent the DFS event notification to the network manager or by the wireless APs that received the avoid channel notifications. In an example, the RF channel 100 is excluded from use for communications and from scanning operations for a fixed time interval, such as 30 min. In an example, the wireless AP that sent the DFS event notification switches to a non-DFS channel so that a CAC delay time (e.g., 60 seconds) can be avoided.

FIG. 4B depicts the set of RF channels 122 from FIG. 2 and illustrates a DFS scanning operation that is performed by a wireless AP that received the avoid channel notification to avoid channel 100 and the avoid channel notification to avoid channel 56. As shown in FIG. 4B, channel 56 and channel 100 are both excluded 140 from scanning 132 implemented by the wireless AP. In the example of FIG. 3, channels 56 and 100 are excluded from scanning by wireless APs, AP1 and AP4. In addition to excluding channel 56 and channel 100 from scanning, in an example, the RF channels 56 and 100 are not used by the wireless APs that sent the respective DFS event notifications to the network manager. In an example, the RF channel 100 is excluded from scanning operations for a fixed time interval, such as 30 min. As illustrated in FIG. 4B, some time intervals for excluded RF channels may overlap. In particular, the time interval for excluding channel 100 overlaps for some period of time with the time interval for excluding channel 56.

After 30 minutes has elapsed since the avoid channel notifications were received for RF channel 100, the exclusion of RF channel 100 will expire at the wireless APs that received the avoid channel notifications. FIG. 4C depicts the set of RF channels 122 from FIG. 2 and illustrates a scanning 132 that is performed by a wireless AP that received the avoid channel notification to avoid channel 56. As shown in FIG. 4C, channel 56 is excluded 140 from scanning by the wireless AP. In the example of FIG. 3, channel 56 is excluded from scanning by wireless APs, AP1, AP3, and AP4. In addition to excluding channel 56 from scanning in the DFS scanning operation, in an example, the RF channel is not used by the wireless AP that sent the DFS event notification to the network manager or by the wireless APs that received the avoid channel notifications. In an example, the wireless AP that sent the DFS event notification switches to a non-DFS channel so that a CAC delay time (e.g., 60 seconds) can be avoided. In an example, the RF channel 56 is excluded from use in communications and from scanning operations for a fixed time interval, such as 30 minutes.

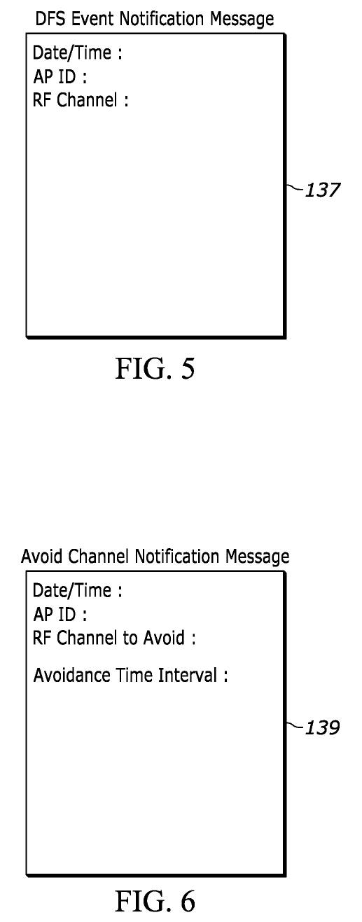

FIG. 5 is an example of a DFS event notification message 137 that is sent from a wireless AP to the network manager as a DFS event notification. In the example of FIG. 5, the DFS event notification message includes fields for a timestamp (e.g., date and time), a wireless AP identifier (e.g., a MAC address of the wireless AP that sent the message), and a channel identifier. The DFS event notification message may include more or less information. For example, a timestamp may not be included in the message. In an example, the DFS event notification message is sent from a wired interface of the wireless AP. In an example, the AP identifier may be the source MAC address of the DFS event notification message.

FIG. 6 is an example of an avoid channel notification message 139 that is sent from the network manager to a wireless AP as an avoid channel notification. In the example of FIG. 6, the avoid channel notification message includes fields for a timestamp (e.g., date and time), a wireless AP identifier, an RF channel identifier, and an avoidance time interval. The avoid channel notification message may include more or less information. For example, a timestamp and/or the avoidance time interval may not be included in the message. In an example, the wireless AP identifier is the destination MAC address of the avoid channel notification message, which is the MAC address of the wireless AP that is the intended target of the avoid channel notification message. In an example, the avoid channel notification message is received at a wired interface of a wireless AP.

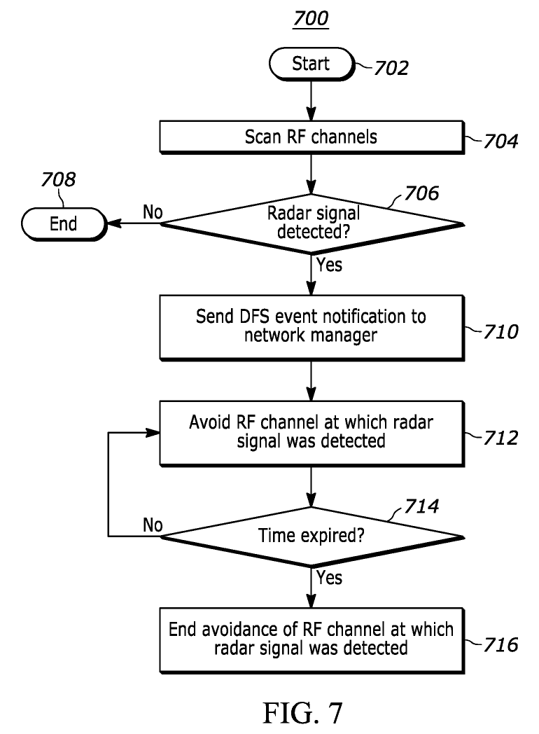

FIG. 7 is a process flow diagram 700 of an example process that is implemented by a wireless AP. Upon starting 702, the wireless AP implements a DFS scanning operation, e.g., a CAC, block 704. At decision point 706, it is determined whether or not a radar signal is detected. If a radar signal is not detected, then the process ends 708. If however, a radar channel is detected, then the wireless AP sends a DFS event notification to a network manager 710. In an example, the DFS event notification is sent from a wired interface of the wireless AP in a DFS event notification message as described with reference to FIG. 5. For example, the wireless AP populates the DFS event notification message with a timestamp, a wireless AP identifier (e.g., a MAC address of the wireless AP), and an RF channel identifier (e.g., an RF channel identifier that corresponds to an RF channel at which the radar signal was detected). In addition to sending the DFS event notification, the wireless AP will avoid using the RF channel at which the radar signal was detected for some limited amount of time, block 712. For example, the wireless AP will not send or receive information on the RF channel and the wireless AP will exclude the RF channel from CACs until some time interval has expired. In an example, the wireless AP adds the RF channel to a channel “not available” list that is maintained at the wireless AP. At decision point 714, it is determined if the time interval has expired. For example, the time interval may be 30 minutes from the time the radar signal was detected. Once the time interval has expired, at block 716, the wireless AP may end avoidance of the RF channel at which the radar signal was detected. For example, the wireless AP may use the RF channel for wireless communications and the wireless AP may include the RF channel in subsequent scanning. In an example, upon expiration of the time interval, the RF channel is removed from the channel not available list that is maintained at the wireless AP.

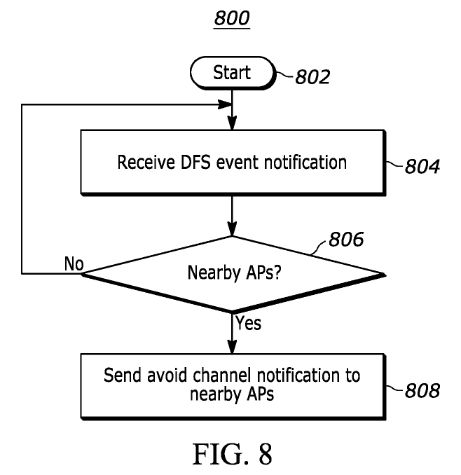

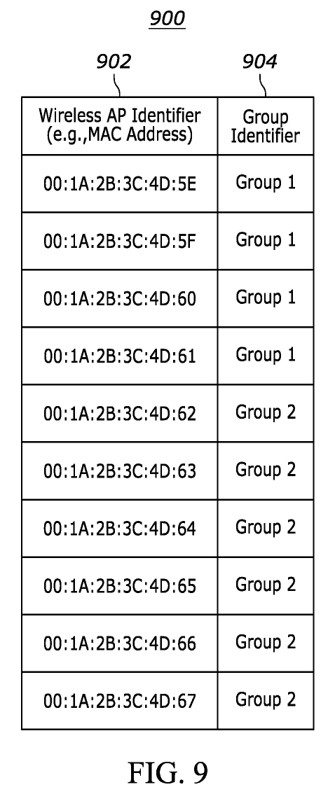

FIG. 8 is a process flow diagram 800 of an example process that is implemented by a network manager. Upon starting 802, at block 804, the network manager receives a DFS event notification, e.g., as a DFS event notification message 137 as described with reference to FIG. 5. At decision point 806, it is determined if there are any wireless APs that are nearby to the wireless AP from which the DFS event notification message was received. In an example, the DFS event notification includes a wireless AP identifier (e.g., MAC address) and the network manager determines if there are any wireless APs nearby to the wireless AP that corresponds to the wireless AP identifier. Examples of operations for determining if there are nearby wireless APs are described below with reference to FIGS. 9 – 11. At decision point 806, if it is determined that there are not any wireless APs nearby, then the process returns to wait for a DFS event notification. If it is determined that there is at least one wireless AP nearby to the wireless AP from which the DFS event notification was received, then at block 808, the network manager sends an avoid channel notification to the wireless APs that are determined to be nearby. In an example, the network manager generates and sends avoid channel notification messages 139 as described with reference to FIG. 6 to each wireless AP that was identified as being nearby to the wireless AP from which the DFS event notification was received. In an example, the avoid channel notification message includes a timestamp, a wireless AP identifier (e.g., the MAC address of the intended recipient of the message), an RF channel identifier of an RF channel that is to be avoided, and an avoidance time interval.

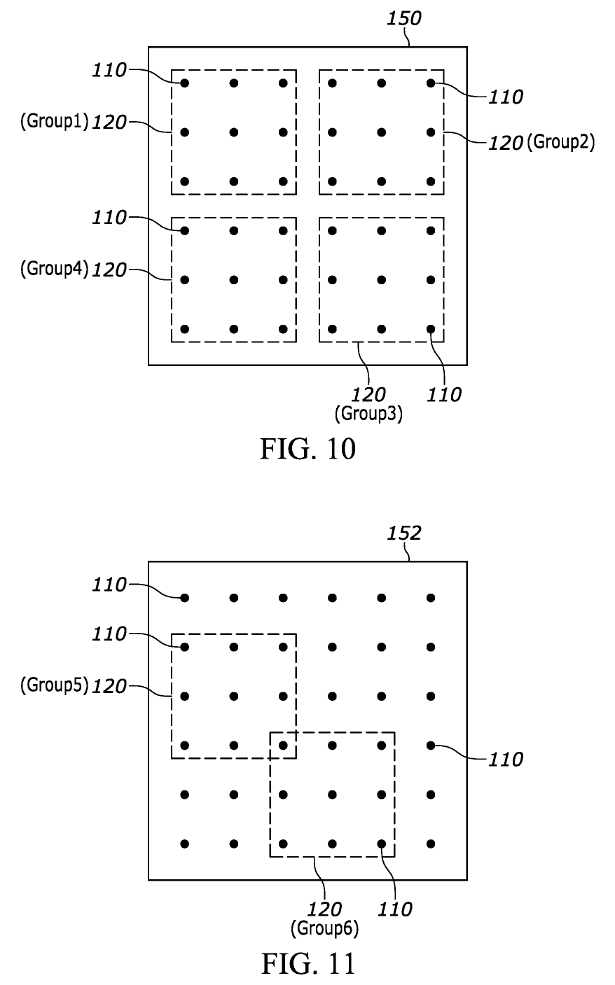

FIG. 9 is an example of a database 900 that is maintained for use by a network manager to determine if any wireless APs are nearby to a wireless AP from which a DFS event notification was received. In the example of FIG. 9, the database includes a column of AP identifiers 902 (e.g., of MAC address) and a column of corresponding group identifiers 904 (group ID). In an example, an AP identifier is associated with a group identifier in the database if the wireless AP is associated with a group that may include more than one wireless AP. For example, groups of wireless APs may be established based on spatial proximity between wireless APs. The spatial proximity that constitutes a group may be based on various different factors. Example factors for establishing a spatial grouping of wireless APs may include wireless APs that are on the same floor of a building, wireless APs that are within a certain distance from each other, wireless APs that are within a certain distance from a common location. Some examples of spatial groups are described with reference to FIGS. 10 and 11. In an example, a network manager can determine if there are any wireless APs in the same group as the wireless AP from which the DFS event notification was received by using the MAC address of the wireless AP from which the DFS event notification was received to find a group identifier and then searching the database to find the wireless AP identifier (e.g., the MAC address) of any entries in the database with a matching group identifier. Although an example of a database is described with reference to FIG. 9, other examples of databases are possible, including other ways of identifying spatial groupings of wireless APs.

FIG. 10 is an example of a floor diagram 150, or floor map, of a building that includes the locations of wireless APs 110 (note that all wireless APs are not labeled with a reference number to preserve clarity in the figure). In the example of FIG. 10, there are thirty-six wireless APs distributed in a grid pattern throughout the floor of the building. Although the wireless APs are distributed in a grid pattern, it should be understood that this is an example distribution of wireless APs, and the wireless APs may be distributed in different ways throughout the building. In the example of FIG. 10, the wireless APs are organized into four spatial groups 120, group 1, 2, 3, and 4. In the example of FIG. 10, the spatial groups have no overlap. That is, there are no wireless APs that are in more than one spatial group. The spatial grouping of the wireless APs may be represented in a database such as the database described with reference to FIG. 9 as having a common group identifier. Given the spatial groupings shown in FIG. 10, if a wireless AP in group 1 sends a DFS event notification to a network manager, then the network manager will determine that all of the other wireless APs included in group 1 are spatially grouped with that wireless AP. Thus, all of the other wireless APs in group 1 would receive a corresponding avoid channel notification.

FIG. 11 is another example of a floor diagram 152, or floor map, of a building that includes the locations of wireless APs 110 (note that all wireless APs are not labeled with a reference number to preserve clarity in the figure). In the example of FIG. 11, there are also thirty-six wireless APs distributed in a grid pattern throughout the floor of the building. Although the wireless APs are distributed in a grid pattern, it should be understood that this is an example distribution of wireless APs and the wireless APs may be distributed in different ways throughout the building. In the example of FIG. 11, the wireless APs are organized into two spatial groups 120, group 5 and 6, although there could be more spatial groups. In the example of FIG. 11, the spatial groups have some overlap in that there are some wireless APs that are included in both of the spatial groups. For example, there is one wireless AP that is included in both group 5 and group 6. Given the spatial groupings shown in FIG. 11, if a wireless AP in group 6 sends a DFS event notification to a network manager, the network manager will determine that all of the other wireless APs included in group 6 are spatially grouped with that wireless AP. Thus, all of the other wireless APs in group 6 would receive a corresponding avoid channel notification.

It should be noted that although two examples of spatial grouping have been described, other spatial groupings are possible. Other criteria that may be used to established spatial groupings may include radio signal range of wireless APs, building features (e.g., walls, doors, floor, stairs, departments), or mobility groups.

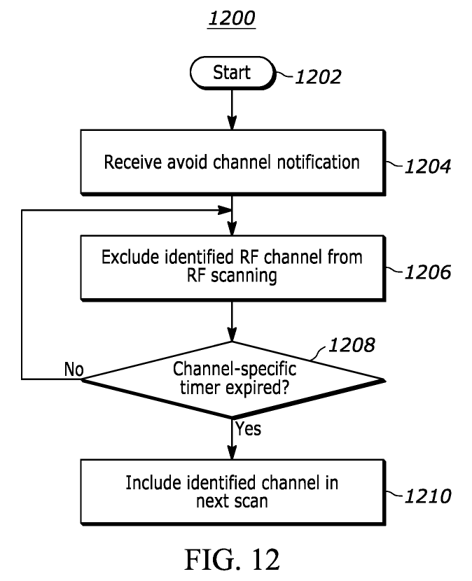

FIG. 12 is a process flow diagram 1200 of another example process that is implemented by a wireless AP. Upon starting 1202, at block 1204 the wireless AP receives the avoid channel notification, e.g., as an avoid channel notification message 139 as described with reference to FIG. 6, which includes a channel identifier. At block 1206, the wireless AP excludes the RF channel that is identified in the avoid channel notification from RF scanning. In an example, the wireless AP excludes the RF channel from scanning by adding the RF channel to a not available list that is maintained at the wireless AP. In an example, the wireless AP will exclude the RF channel at which the radar signal was detected from scanning for some limited amount of time. For example, the wireless AP will exclude the channel from scanning until some time interval has expired. At decision point 1208, it is determined if the time interval has expired. For example, the time interval may be 30 minutes from the time the avoid channel notification was received. In one example, the time interval is taken from the avoid channel notification message and in another example, the time interval is preprogrammed into the wireless AP. Once the time interval has expired, at block 1210 the wireless AP may end exclusion of the RF channel from scanning, for example, by removing the RF channel from the channel not available list that is maintained at the wireless AP. In an example, the wireless AP may then include the RF channel in subsequent DFS scanning operations and the wireless AP may use the RF channel for wireless communications.

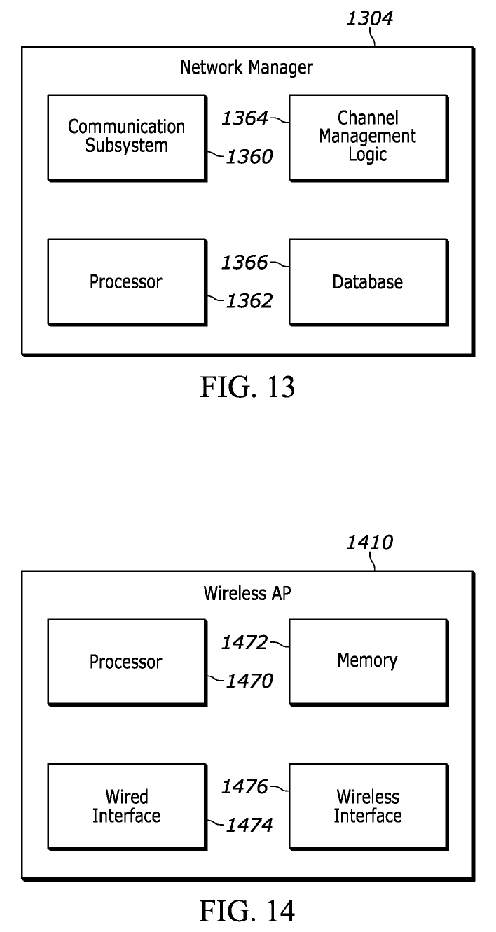

FIG. 13 is an example of a network manager 1304 that is configured to implement RF channel management as described herein. The network manager represents an embodiment of the network manager 104 described with reference to FIGS. 1 and 3, and may be configured to perform the network manager operations described with reference to FIG. 8. In an example, the network manager is an element of an overlay network such as an SD-WAN. The network manager includes a communications subsystem 1360, a processor 1362, channel management logic 1364, and a database 1360.

The communications subsystem 1360 is configured to transmit/receive data to/from the wireless APs in the network. For example, the communications subsystem is configured to receive and process DFS event notifications from the wireless APs and to generate and send avoid channel notifications to the wireless APs in the network.

In an example, the channel management logic 1364 is configured to implement operations of the network manager as described herein. For example, the channel management logic may process DFS event notifications and determine if there are any wireless APs that are spatially grouped with the wireless AP from which the DFS event notification was received.

In an example, the database 1366 is a database similar to the database 900 described with reference to FIG. 9, which includes wireless AP identifiers and corresponding group information, e.g., group identifiers. In an example, the channel management logic accesses the database to determine if there are any wireless APs that are spatially grouped with the wireless AP from which the DFS event notification was received. If such wireless APs are identified, the channel management logic generates corresponding avoid channel notifications.

Although the network manager 1304 is shown as including certain components that perform certain operations, the network manager is not limited to such components and/or operations. For example, network manager may include more or less components that perform the same or different operations. The network manager may be implemented in computer readable instructions that are implemented on a computer server, or computer servers. For example, the computer server includes one or more processors and memory that store and/or execute the computer readable instructions to implement at least some of the operations described herein.

FIG. 14 is a functional block diagram of a wireless AP 1410 that may be similar to any of the wireless APs described herein. In the example of FIG. 14, the wireless AP includes a processor 1470, memory 1472, a wired interface 1474, and a wireless interface 1476. In an example, the wired interface is an interface for wired communications such as a wired Ethernet interface and the wireless interface is an interface for wireless communications such as a WI-FI interface. In an example, the wireless AP may not include a wired interface and may be coupled to other devices, such as a cloud services gateway or intermediate switch, through its wireless interface. In an example, the wireless AP is configured to implement operations of a wireless AP as described herein.

Although DFS scanning is detecting the presence of a radar signal in one example, in other examples, the wireless AP could scan for detectable RF interference that is other than a radar signal.

In some examples, spatial grouping may be manually identified by an installer upon installing the wireless APs and/or the spatial grouping may be automatically learned using information collected by the wireless APs and/or by the network manager.

The embodiments disclosed herein can be implemented through at least one software program running on at least one hardware device and performing network management functions to control the network elements. The network elements shown in FIG. 13 and/or FIG. 14 include blocks which can be at least one of a hardware device, or a combination of a hardware device and a software module. It is understood that the scope of the protection for systems and methods disclosed herein is extended to such a program and in addition to a computer readable means having a message therein, such computer readable storage means contain program code means for implementation of one or more steps of the method, when the program runs on a server or mobile device or any suitable programmable device.

In an embodiment, the functionality described above is performed by a computer device that executes computer readable instructions (software). Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the above-described techniques are described in a general context, those skilled in the art will recognize that the above-described techniques may be implemented in software, hardware, firmware, or any combination thereof. The above-described embodiments of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention. The computer readable media may comprise, for example, RAM (not shown) contained within the computer. Alternatively, the instructions may be contained in another computer readable media such as a magnetic data storage diskette and directly or indirectly accessed by a computer system. Whether contained in the computer system or elsewhere, the instructions may be stored on a variety of machine readable storage media, such as a DASD storage (e.g., a conventional "hard drive" or a RAID array), magnetic tape, electronic read-only memory, an optical storage device (e.g., CD ROM, WORM, DVD, digital optical tape), paper "punch" cards. In an illustrative embodiment of the invention, the machine-readable instructions may comprise lines of compiled C, C++, or similar language code commonly used by those skilled in the programming for this type of application arts.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for operating a network, the method comprising:
at a first wireless access point (AP), generating a Dynamic Frequency Selection (DFS) event notification message in response to a radio frequency (RF) scanning operation that identifies a radar signal at an RF channel, the DFS event notification message including an identifier of the first wireless AP and an identifier of the RF channel;
at the first wireless AP, transmitting the DFS event notification message to a network manager;
at the network manager, identifying at least one wireless AP that is spatially grouped with the first wireless AP using the first wireless AP identifier that was included in the DFS event notification message;
at the network manager, generating an avoid channel notification message in response to the DFS event notification message, the avoid channel notification message including the RF channel identifier that was included in the DFS event notification message;
at the network manager, transmitting the avoid channel notification message to the at least one wireless AP that was identified as being spatially grouped with the first wireless AP; and
at the at least one wireless AP that was identified as being spatially grouped with the first wireless AP, receiving the avoid channel notification message and implementing an RF scanning operation that excludes the RF channel that is identified by the RF channel identifier in the avoid channel notification message.

2. The method of claim 1, wherein the avoid channel notification message includes an exclusion time, and wherein the RF channel is excluded from the RF scanning operation by the at least one wireless AP in accordance with the exclusion time included in the avoid channel notification message.

3. The method of claim 1, wherein the RF channel is excluded from the RF scanning operation for a fixed period of time.

4. The method of claim 1, wherein the RF channel is excluded from the RF scanning operation for 30 minutes.

5. The method of claim 1, wherein identifying at least one wireless AP that is spatially grouped with the first wireless AP using the first wireless AP identifier that was included in the DFS event notification message includes finding wireless APs that have a group identifier that matches a group identifier of the first wireless AP.

6. The method of claim 1, wherein the first wireless AP identifier is a media access control (MAC) address, and wherein identifying at least one wireless AP that is spatially grouped with the first wireless AP using the first wireless AP identifier that was included in the DFS event notification message includes finding the MAC addresses of wireless APs that have a group identifier that matches a group identifier of the first wireless AP.

7. The method of claim 1, wherein the at least one wireless AP that was identified as being spatially grouped with the first wireless AP includes multiple wireless APs that are identified as being spatially grouped with the first wireless AP.

8. The method of claim 7, further including:
at the network manager, transmitting the avoid channel notification message to the multiple wireless APs that are identified as being spatially grouped with the first wireless AP; and
at each one of the multiple wireless APs that are identified as being spatially grouped with the first wireless AP, implementing an RF scanning operation that excludes the RF channel that is identified by the RF channel identifier in the avoid channel notification message.

9. The method of claim 1, wherein the first wireless AP identifier is a media access control (MAC) address corresponding to the first wireless AP identifier.

10. The method of claim 1, wherein the DFS event notification is transmitted from a wired interface of the first wireless AP.

11. The method of claim 1, wherein:
at the first wireless AP, transmitting the DFS event notification message via a wired interface of the first wireless AP; and
at the at least one wireless AP that was identified as being spatially grouped with the first wireless AP, receiving the avoid channel notification message via a wired interface of the at least one wireless AP.

12. A non-transitory computer readable medium comprising instructions, which when executed by one or more processes, implement a method comprising:
at a network manager, receiving a Dynamic Frequency Selection (DFS) event notification message, the DFS event notification message including an identifier of a first wireless AP and an identifier of a radio frequency (RF) channel;
at the network manager, identifying at least one wireless AP that is spatially grouped with the first wireless AP using the first wireless AP identifier that was included in the DFS event notification message;
at the network manager, generating an avoid channel notification message in response to the DFS event notification message, the avoid channel notification message including the RF channel identifier that was included in the DFS event notification message; and
at the network manager, transmitting the avoid channel notification message to the at least one wireless AP that was identified as being spatially grouped with the first wireless AP.

13. The non-transitory computer readable medium of claim 12, wherein identifying at least one wireless AP that is spatially grouped with the first wireless AP using the first wireless AP identifier that was included in the DFS event notification message includes finding wireless APs that have a group identifier that matches a group identifier of the first wireless AP.

14. The non-transitory computer readable medium of claim 12, wherein the first wireless AP identifier is a media access control (MAC) address, and wherein identifying at least one wireless AP that is spatially grouped with the first wireless AP using the first wireless AP identifier that was included in the DFS event notification message includes finding the MAC addresses of wireless APs that have a group identifier that matches a group identifier of the first wireless AP.

15. The non-transitory computer readable medium of claim 12, wherein the DFS event notification message is generated at a wireless AP in response to a radio frequency (RF) scanning operation that identifies a radar signal at the RF channel, and further including at the at least one wireless AP that was identified as being spatially grouped with the first wireless AP, implementing an RF scanning operation that excludes the RF channel that is identified by the RF channel identifier in the avoid channel notification message.
